(19) United States
(12) Patent Application Publication
(10) Pub. No.: US 2014/0025462 A1
(43) Pub. Date: Jan. 23, 2014

(54) Promotion System And Method

(71) Applicant: Sebastian Ralph Langton, New South Wales (AU)

(72) Inventor: Sebastian Ralph Langton, New South Wales (AU)

(73) Assignee: WYN Factory Pty Ltd, New South Wales (AU)

(21) Appl. No.: 14/009,362

(22) PCT Filed: Apr. 4, 2012
(86) PCT No.: PCT/AU2012/000340

§ 371 Date: Oct. 2, 2013

(30) Foreign Application Priority Data
Apr. 4, 2011 (AU) 2011901223
May 2, 2011 (AU) 2011901605

(51) Int. Cl. G06Q 30/02

(52) U.S. Cl. CPC G06Q 30/0222
USPC 705/14.23

(57) ABSTRACT

A method of providing a buying incentive to a customer for the purchasing of at least one item of value, the method comprising the steps of: (a) advertising to a customer the option of buying at least one item in a series of the items of value, with predetermined special members of the series being able to be purchased for a special price, the special members being unknown to the user; (b) providing a user with the option to precommit to buying at least one of the items of value; (c) utilizing the series, including any predetermined special members having a special price, to determine the total cost to the customer of the purchase; and (d) fulfilling the purchasing requirements of the purchase.

### FIELD OF THE INVENTION

The present invention relates to a system and method for transaction processing via the creation of buying incentives without the need to discount.

### BACKGROUND

Sales promotions have become synonymous with discounting in all forms as a method to create a buying incentive. Discounting devalues the brand as well as the good(s) and/or service(s) offered and results in a spiralling competition of reduced pricing. Discounting is problematic because the supplier may be unable to sustain the ensuing price war as margins decline. Whilst the consumer initially benefits from the reduction in price, there is often a consequential eventual degradation of the quality of good(s) and/or service(s) being offered.

Discounting allows existing customers to pay heavily reduced prices for the goods and/or services they were previously happy to pay full price for and allows new customers to exploit the offers, often unwilling to return when faced with the full price. Businesses struggle to survive when they replace good quality paying customers with poor quality bargain shoppers. Unsustainable discounted prices are becoming accepted as the normal price, making it significantly more difficult to reward loyalty or provide a buying incentive without damaging profits. The spiralling decline in pricing, quality and brand value was happening at a moderate rate in traditional local markets, but the growing accessibility of the World Wide Web with the ability to compare prices nationally and globally as well as new online business models which focus on discounting has significantly accelerated this decline. The current discounting environment has resulted in a greater volume of sales at virtually unsustainable margins, thereby creating a very unstable retail economy.

The present invention is directed at providing a method and system that provides a useful alternative for sellers to promote the sale of their good(s) and/or services(s).

### SUMMARY OF THE INVENTION

In accordance with a first aspect of the present invention, there is provided a method of providing a buying incentive to a customer for the purchasing of at least one item of value, the method comprising the steps of: (a) advertising to a customer the option of buying at least one item in a series of the items of value, with predetermined special members of the series which will be sold at a special price (b) providing a customer with the option to precommit to buying at least one of the items of value; (c) utilizing the series, including any predetermined special members having a special price, to determine the total cost to the customer of the purchase; and (d) fulfilling the purchasing requirements of the purchase.

The step (a) further preferably can include advertising to the customer a frequency of the special members within the series.

In accordance with a further aspect of the present invention, there is provided a purchasing incentive system for providing purchases of items of value, the system including: an interrogation device for customers to integrate the incentive system to determine possible items of value for purchasing; a notification device for notifying customers of the option of buying a series of the items of value, with predetermined special members of the series being able to be purchased for a special price, the special members being unknown to the customer; a payment processing unit for processing precommitment purchasing requests from customers for items of value; a payment adjustment unit interconnected to the notification device and payment processing unit for adjusting the level of payment in accordance with whether any of the items of value for purchasing are predetermined special members of the series.

### BRIEF DESCRIPTION OF THE DRAWINGS

Preferred embodiments of the present invention will now be described with reference to the accompanying drawings in which:

FIG. 1 illustrates product purchasing margins;

FIG. 2 illustrates an internet based environment for operation of the preferred embodiment;

FIG. 3 and FIG. 4 illustrate screen shots of the operation of the preferred embodiment;

FIG. 5 illustrates a flow chart of the steps of operation of the preferred embodiment;

FIG. 6 illustrates an internet based environment for operation of the preferred embodiment; and

FIG. 7 illustrates the steps involved in a customer process in one form of operation of the preferred embodiment.

### DESCRIPTION OF PREFERRED AND OTHER EMBODIMENTS

The preferred embodiment utilises the concept of ratio shopping. The Ratio Shopping Transactional Process was conceived as a unique way of using the available margins on good(s) and/or service(s) to create a buying incentive without the need to discount. The key to the process is a custom built Ratio Engine Algorithm which typically sits between the merchant and payment gateway. This algorithm works with a sequential ordering system which allocates a special price defined by a ratio or odds to individual purchases within the sequence of items. The chance of purchasing a special priced item is transparent to the customer and is depicted in the form of a ratio or odds for each item, which determines the frequency of the special prices in the sequence of items to be sold. The current position within the sequence is not transparent to the customer, so it's not apparent when the next special price item will be sold.

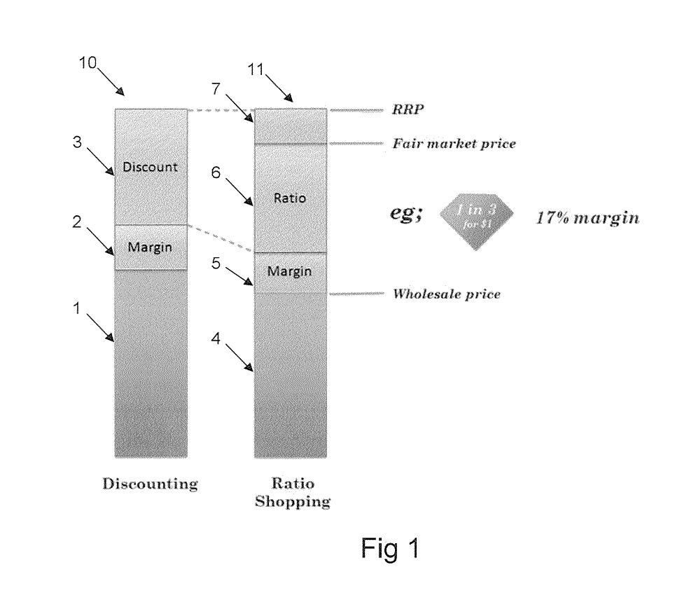

Other discount models merely use part of the available margin to offer a discount. The Ratio Shopping Transactional Process differs by instead using part of the available margin to create a Ratio Shopping Incentive. By not offering a discount on every item, the unique Ratio Shopping business model is able to combine the margins allocated to the ratio from the sale of each of the normal price items to offset the cost of the special price items. For example, FIG. 1 illustrates initially the margins available for the discounting process 10. These include a wholesale price 1, sellers' margin 2 and a discount 3. In the preferred embodiment 11, a portion of the overall margin from each sale is allocated to create the ratio. The sale price is then made up of the wholesale price 4, the margin 5 and the ratio component 6. It is noted that items may be sold at the fair market price 7 instead of the RRP. It is also noted that the Ratio Shopping model may attract a lower wholesale price due to the discount not being offered to the customer. For example, a wholesale margin of 50% allows for every 3rd item in the sequence to be sold for $1 while capturing 16.7% margin on each sale.

While most sales incentive business models favour either the consumer or the supplier, the Ratio Shopping process of the preferred embodiment creates a balance between the needs of the suppliers and the consumers. Suppliers are able to protect their price point, brand value and attract loyal returning customers, equally consumers benefit from quality products, exceptional value and a unique buying experience.

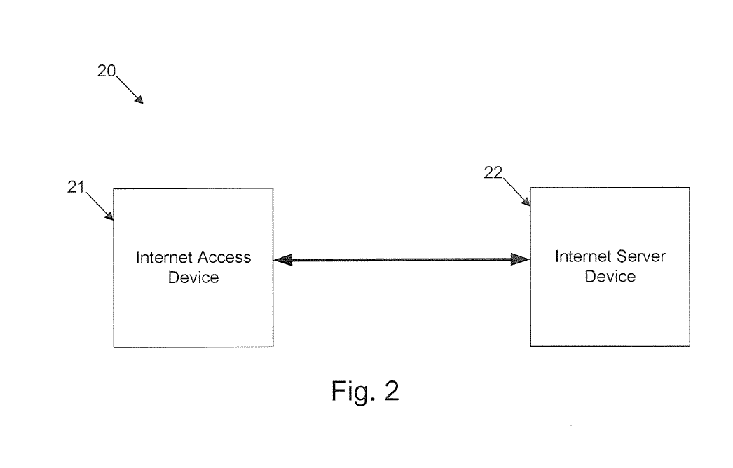

Whilst the ratio shopping concept can have a general implementation, one form of implementation is an internet browser type implementation. As illustrated in FIG. 2, the preferred embodiment 20 is implemented on an internet server device 22 which is adapted for interrogation by an internet access device 21.

The internet server device operates in the usual manner and implements a Ratio Shopping Transactional Process and the Ratio Engine Algorithm that enables the model. By adopting this process, sellers are able to avoid the detrimental effects of discounting. Sellers are thereby able to provide the ability to promote the sales of good(s) and/or service(s) without the need to discount or compete on price, but also encourages the consumer to purchase individually, in bulk or as a group with friends, by offering the special price as a significant incentive.

The preferred embodiment thereby provides a process for the sale of good(s) and/or service(s) which provides a special price to pre-determined items in a batch by means of a ratio which defines the frequency and an initiator which defines the allocation of the special prices to the items in the purchasing sequence. This process was conceived to provide sellers with the ability to create a buying incentive without the need to discount or devalue the individual good(s) and/or service(s), therefore enabling them to maintain brand positioning and the price point of their good(s) and/or service(s).

The Ratio Engine Algorithm defines the frequency and allocation of a special price in a sequential ordering system, specific to the individual good(s) and/or service(s) purchased. Existing systems and processes are combined with the custom developed algorithm in a unique way to generate the Ratio Shopping Transactional Process. This transactional process maintains the price point of individual good(s) and/or service(s) whilst offering the chance of a special price defined by the Ratio Engine Algorithm and depicted to the consumer as a ratio or odds (eg; 1 in 3). The Ratio Shopping Transactional Process has been designed to work alongside or replace the current online and point of sale transactional processes allowing for a new sales format and customer incentive.

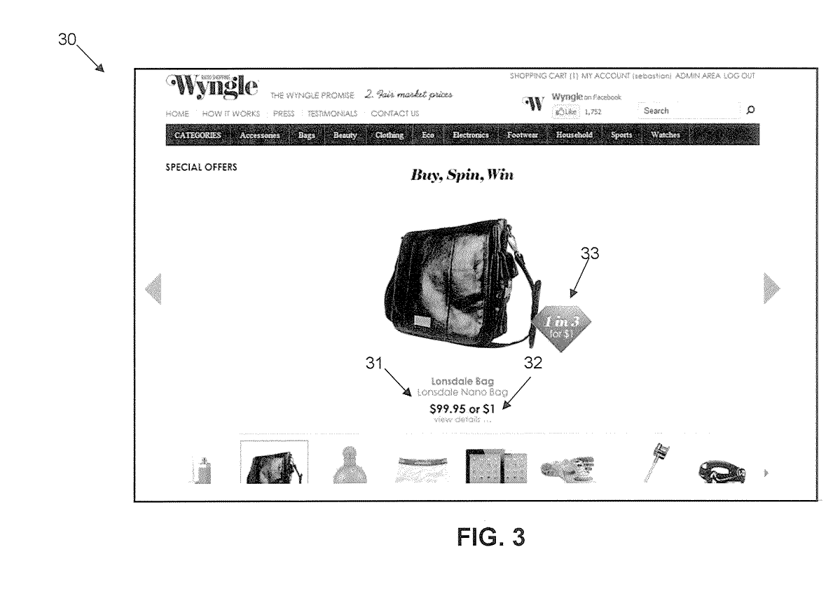

By way of example, FIG. 3 illustrates an initial screen shot 30 of the user interface of the preferred embodiment. The premise of the preferred embodiment is that the customer is offered the purchase of a particular good or service at a competitive price 31 with the chance 33 to purchase the product or service at a special nominal price 32. This allows the purchaser the opportunity to buy one item with a 1 in X chance 33 of paying the special nominal price or to buy the full sequence of items to achieve guaranteed savings on bulk purchases. In the preferred embodiment, the special price items are allocated sequentially, not randomly so customers can be sure of the integrity of the system in allocating the special prices. The ratio may be denoted by A in B, A:B, A to B, every nth, or any other form which provides some insight into the frequency or allocation of the special price items.

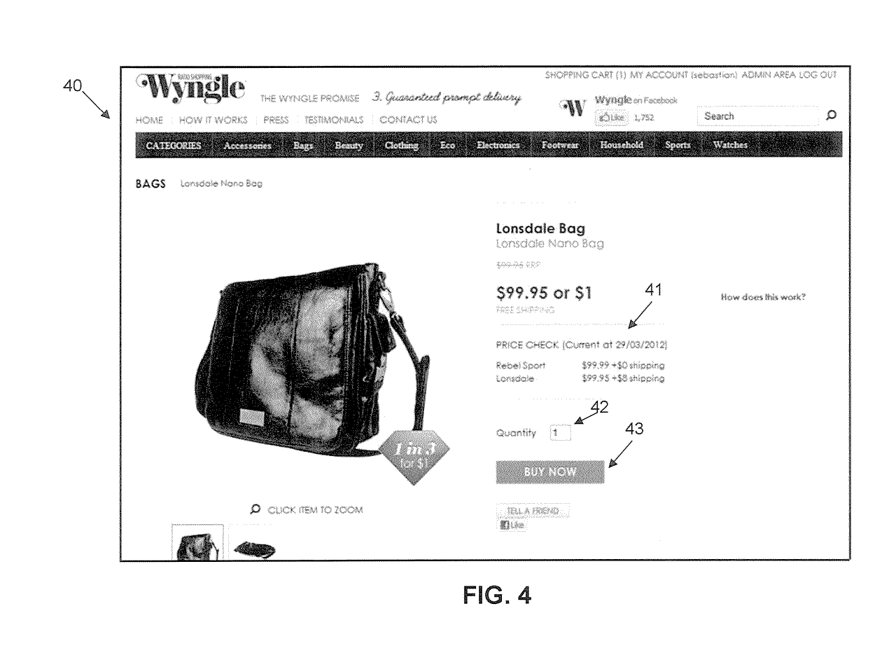

Turning now to FIG. 4, there is illustrated a subsequent screen 40 utilised on selection of a particular product by a customer. In this screen, the customer is again presented with the option of purchasing goods. However, the purchaser is also presented with comparative pricing information which can be entered manually or automatically. Additionally, the purchaser is able to buy a number of the items with the promise that ‘1 in 3’ will be able to be purchased for a nominal amount, meaning every third item will be sold for $1. A purchasing button is also provided which will take the customer to a check-out/payment confirmation page where the customer will be required to precommit to pay the advertised price of the item/s before finding out whether they will pay the advertised price or the special price.

The Ratio Shopping Model uses the available margin to determine a ratio for each of the good(s) and/or service(s) advertised. The ratio is displayed in conjunction with the advertised price (commonly the fair market price). This ratio replaces the need to offer a typical discount for individual purchases, encouraging both individual and bulk purchases (e.g. a ratio of 1 in 3 equates to a 33% discount overall if the customer purchases 3 items). This ratio represents the odds of a customer paying the special price offered, in order to promote sales. In the example of a 1 in 3 ratio, every 3rd purchase in the sequence of items will be sold at a special price. This means if the customer purchases one item, they have a 1 in 3 chance of getting the special price. The position that the customer purchases within the sequence of items on offer will determine whether the special price is paid or the normal price is paid. If the customer purchases two items, they have a 2 in 3 chance of getting the special price, or if they purchase three items, they will be guaranteed to get one item for the special price and will pay the advertised price for the other two items.

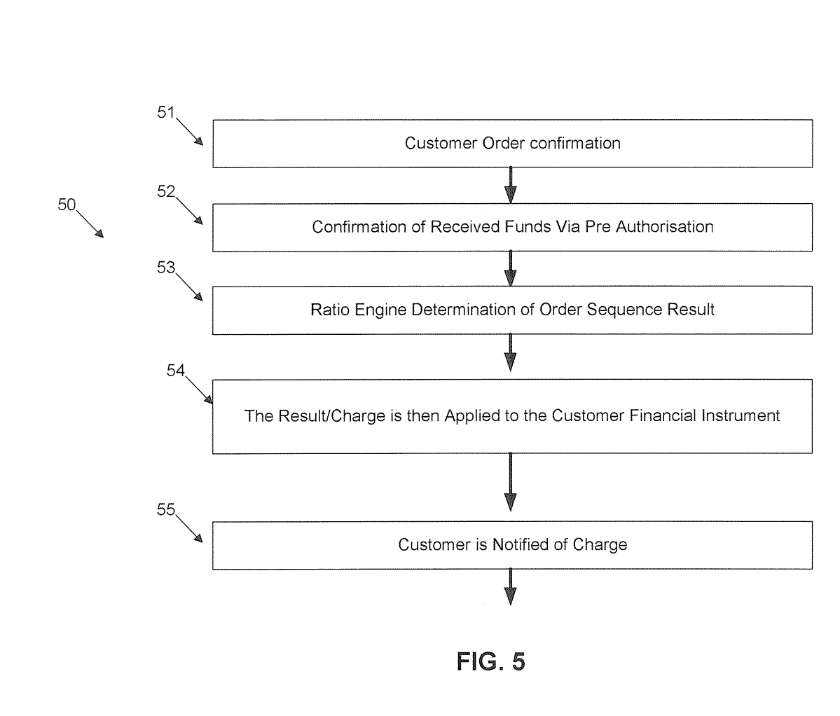

The steps, comprising the Ratio Shopping Transactional Process 50 are implemented by the Ratio Engine System and can be as illustrated in FIG. 5. The initial step is for the purchaser to place an order 51 and receive an order confirmation. A check out process is undertaken and a financial instrument is confirmed 52 for available funds and available funds are held. Next, the Ratio Engine Algorithm references 53 the order against the sequential ordering system to determine the price of the good(s) and/or service(s), ie. whether the special price applies. Next, the determined price is charged 54 to the financial instrument. Next, the customer is informed of the price 55.

The Ratio Shopping Transactional Process allocates a special price according to the ratio and sequence initiator and charges the customer in accordance with their position in the sequence of items. The sequence initiator determines the position of the first special priced item in the sequence of items and the ratio determines the frequency of the following special price items. Thus for a ratio of 1 in 3 with a sequence initiator of 2, the first item to be allocated the special price is the 2nd item, then the 5th, 8th and 11th etc. For example, the * in the following sequence denotes special pricing with a ratio of 1:3 and a sequence initiator of 2: 1 2* 4 5* 6 7 8* 9 10 11* 12 . . . The start of the sequence can begin at another designated starting point.

The process is initiated by the customer confirming the purchase, then the required amount of funds (equal to the full advertised price) is confirmed to be available and are held (via a payment, a payment pre-authorisation, escrow or similar process). The Ratio Engine System then matches the requested number of items to the batch of those items in the ordering system starting with the next available and determines whether any of these items are designated for a special price according to the ratio and sequence initiator for each item. It is only then that it is revealed to the customer whether the purchase includes any special price items.

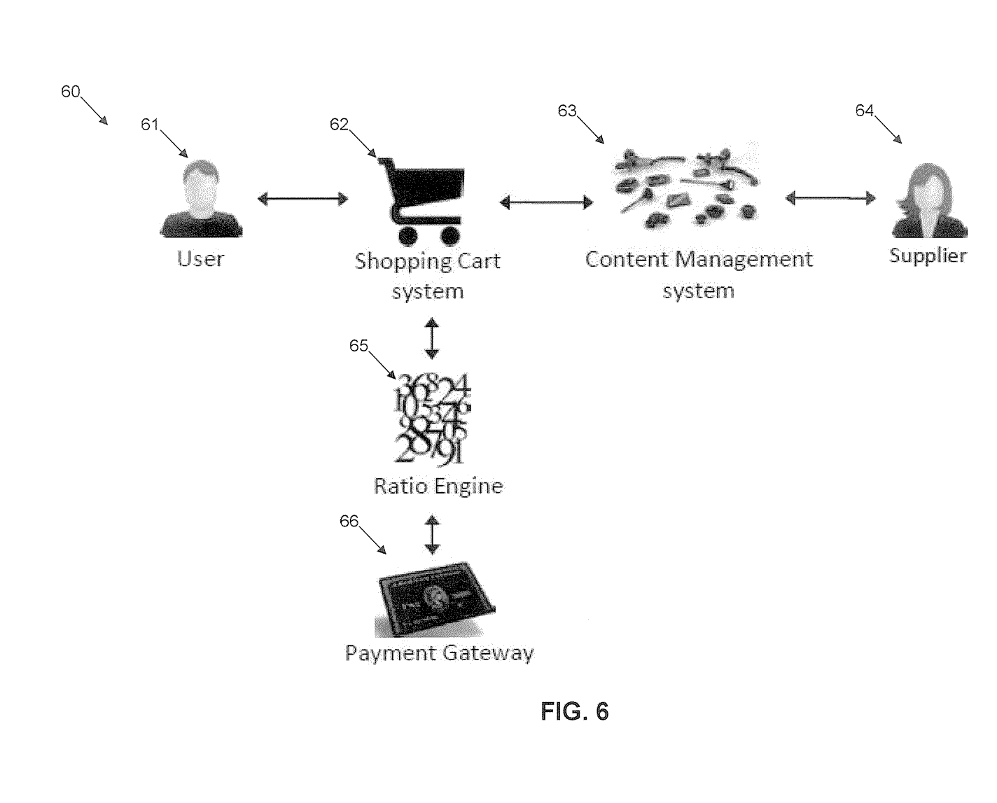

Whilst the ratio shopping concept can have a general implementation, one form of implementation is an ecommerce type implementation. As illustrated in FIG. 6, the preferred embodiment 60 involves a user 61 who browses and selects items for purchase via a shopping cart system 62. These items are stored in a back-end content management system 63 which is managed by one or more suppliers 64 of goods and/or services. The innovative Ratio Engine System 65 sits between the shopping cart system and the Payment Gateway 66 and determines whether the items selected for purchase by the user are charged at the advertised price or a special price. This structure can be implemented in a variety of ways where any or all of the parts may be from within the same organisation, or from multiple organisations. This structure could apply to a number of business models including but not limited to a standalone ecommerce model, a marketplace, a reseller model, a licensing model or a distribution model.

By way of review, the steps involved in the programming logic of the Ratio Engine System can be as follows:

1. An order is placed on the system.

2. The system checks the Order States via order.getState( )==OrderState.PRE_AUTH_SUCCESSFUL

3. There are 4 steps defined during the Pre_auth process including confirming there are available funds on the nominated credit card. If the order states have not been verified, the system will reject the order and exit the queue. If the order has been approved through the pre auth process, then all the approved transactions will enter the sequential ordering system. The system uses message queues to queue the transactions by the precise datetime element.

4. The ratio engine will check the stock availability of the requested item/s before processing the order. If the stock is not available, it will return a relevant message to the user.

5. If stock is available, the transaction will be processed by the ratio engine using the following logical statement: IF (transactionNumber−sequenceInitiator) % sequenceLength==whole number THEN transactionNumber is a winning transaction. The sequenceLength refers to the consequent term (the second number) in the ratio eg; sequenceLength=3 for a ratio of 1 in 3. A relevant message is then sent to the user informing them of the outcome.

6. The system then commits the changes to the database based on the results and completes the fulfilment process.

### Implementation

The following information describes one form of implementation of the Ratio Shopping Model. In order to implement the Ratio Shopping Model, a seller would need to complete 4 major steps as detailed below:

Step 1. The seller would need to establish the ratios associated with the good(s) and/or service(s) being sold. This can be done by using the following equation: Ratio=Sell Price/(Sell Price−Buy Price). The Buy Price should include all associated costs including shipping and transaction fees. The sellers' margin will be made up of the remainder of the above division calculation. For example: Buy Price=$70, Sell Price=$100, Ratio=100/(100−70)=3.33. This gives a ratio of 1 in 3 with the 0.33 being available as the sellers' margin.

Step 2: The seller would then select the sequence initiator for each batch of good(s) and/or service(s), which will determine the first item in the sequence to be allocated a special price. Assuming the above example with a ratio of 1 in 3, if the seller selects 2 as the sequence initiator, the following sequence would result, where the numbers marked with an * are those sold for the special price:

2* 3 4 5* 6 7 8* 9 10 11* 12.

Step 3: The seller will then need to create the Ratio Engine System which implements the Ratio Engine Transaction Process. This will be to be capable of sequentially allocating the special price items within a series of items. The Ratio Engine System will typically sit between the customer, the seller and the payment gateway.

Step 4: The seller would then promote and encourage the sale of good(s) and/or service(s) through the Ratio Shopping Model with the use of a ratio or odds to describe the opportunity to the customer. For example: $100 or 1 in 3 for $1.

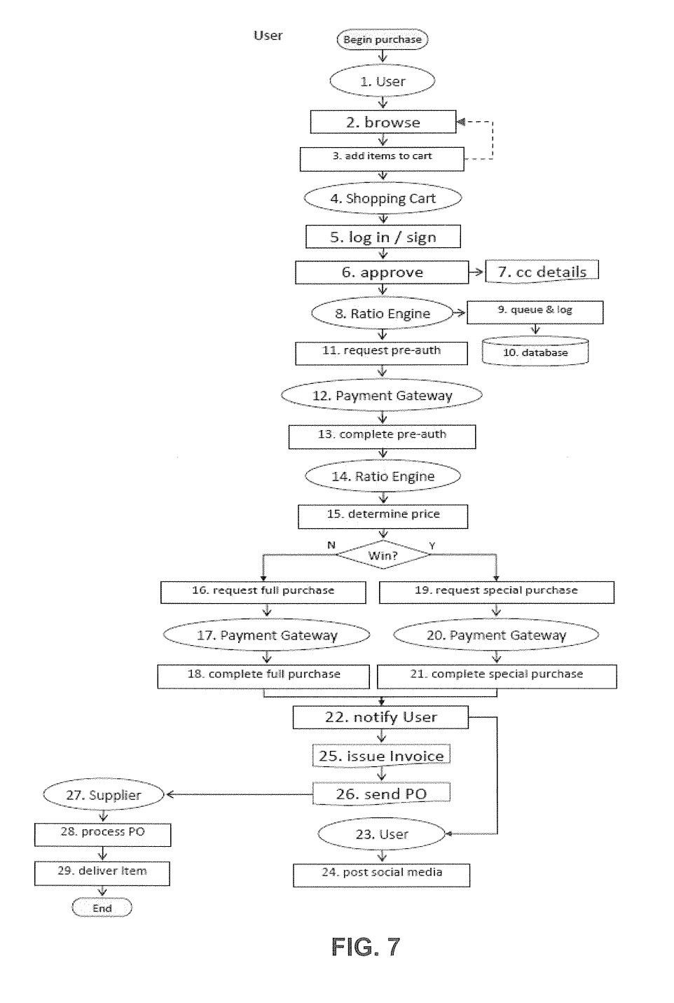

The User Process can be as implemented in FIG. 7 and includes the following sub steps: 1. The User visits the site and is taken to the homepage with no login required. 2. The User is able to browse the Items available on the site either by scrolling through all Items on the homepage, by browsing through the categories or by searching on a keyword or other search parameters such as price. 3. Once the User finds an item that they'd like to purchase, they can add it to their shopping cart. They can view the Items in their cart and continue browsing to add more Items as required. 4. The User can view all Items in the Shopping Cart and modify their selection before proceeding to the check out. 5. The User can either log into the system using their username and password or register with the site if not already signed up. 6. If already registered, the system may use their existing payment details; otherwise the user can enter their credit card details to approve the purchase. 7. The credit card details will be handled securely to ensure the secure integrity of the transaction. 8. The Ratio Engine can receive the purchase request from the Shopping Cart. 9. The system can queue all requests and time stamp them to ensure chronological processing. 10. All data can be securely logged in the database. 11. The Ratio Engine can request for the pre-authorisation to be made. 12. The Payment Gateway can receive the pre-authorisation request. 13. The pre-authorisation can be processed by the merchant bank. 14. Once the Payment Gateway has confirmed that the pre-authorisation has been approved and successfully completed by the merchant bank, the Ratio Engine reviews the transactions which were processed in the queue. 15. The Ratio Engine applies the Ratio and Sequence Initiator to determine whether any of the items are allocated a special price. 16. For the normal price items, a full purchase amount is requested from the Ratio Engine. 17. The Payment Gateway receives the purchase request. 18. The full purchase amount is processed by the merchant bank. 19. For the winning transactions, a special price amount is requested from the Ratio Engine. 20. The Payment Gateway receives the purchase request. 21. The special price amount is processed by the merchant bank. 22. Immediately after confirming the purchase, a notification is sent to the User confirming whether they paid the normal price or the special price. 23. The User receives the notification. 24. The User can post the outcome using social media such as Facebook and Twitter. 25. An Invoice can be emailed to the User to confirm the payment and delivery details. 26. A Purchase Order can be emailed to the Supplier to confirm the purchase information including the User's delivery instructions. 27, The Supplier can receive an email Invoice as well as a copy which can appear in the orders section of their admin login. The system may interface directly into the Suppliers' sales order management system. 28. The Supplier can process the Purchase Order in their sales order management system. 29. The Item can then be delivered to the User. If it's a physical Product, it can be shipped to the User's delivery address. If it's a Service or a digital Product such as a coupon or license, it can be emailed to the User.

The preferred embodiments thereby provide a purchasing system that provides incentives for users which do not rely on discounting.

It can therefore be seen that the preferred embodiment provides for the use of a computerized system utilizing a ratio to determine the frequency and allocation of a special price to good(s) and/or service(s) during the purchase process. The resultant system can be denoted a Ratio Engine System.

The sales model allows for the promotion of good(s) and/or service(s) by means of a ratio defining the allocation frequency of a special price as a buying incentive. The special price or refund is systematically given to the consumer directly after purchase or pre-authorization, determined by a ratio relating to the individual good(s) and/or service(s) purchased.

There are at least two methods by which the financial instrument can be used to capture the precommitment and then charge the resulting price. This can be achieved by either a pre-authorisation method or a purchase and refund method. With the pre-authorisation method, the financial instrument, such as a credit card, is used to confirm that funds are available for the full advertised price and those funds are held to ensure that the customer is committed to the purchase. Once the resulting price is determined by the Ratio Engine System, then the card is charged the final amount which is equal to or less than the pre-authorised amount. This pre-authorisation may be handled differently in different cases and by different financial institutions, for example the pre-authorisation amount may be reversed and the final amount then charged, or the pre-authorisation may just be completed if it's for the same amount, in the case of a normal price purchase. The purchase and refund method involves charging the financial instrument for the full advertised amount up-front to get the precommitment and then if a special price is allocated, then refunding part or all of the charged amount to achieve a net price to the customer equal to the nominated special price. It is noted that the price of items may include other costs such as shipping, credit card transaction fees etc.

The use of the Ratio Engine System determines the price of good(s) and/or service(s) sold and charges a financial instrument accordingly. This allows for the promotion of good(s) and/or service(s) online by means of a ratio defining the allocation frequency of a special price as a buying incentive. The special price or refund is systematically given to the consumer directly after pre-authorization or purchase, determined by a ratio relating to the individual good(s) and/or service(s) purchased.

Many modifications of the preferred embodiments are possible. For example, in alternative embodiments, the special price can be varied. Further, in other alternative embodiments, the special price position can be assigned randomly in accordance with a predetermined probability distribution. In a further alternative, the special price can be given one of a finite group of determined values. In a further alternative, the precommitment may be, for example, a significant portion of the overall final price.

### Interpretation

The forgoing description and figures make use of reference numerals to assist the addressee understand the structure and function of the embodiments. Like reference numerals are used in different embodiments to designate features having the same or similar function and/or structure.

The drawings need to be viewed as a whole and together with the associated text in this specification. In particular, some of the drawings selectively omit including all features in all instances to provide greater clarity about the specific features being described. While this is done to assist the reader, it should not be taken that those features are not disclosed or are not required for the operation of the relevant embodiment.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications which fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1-30. (canceled)

31. A buying incentive system including:
a preauthorization unit for confirming the commitment to purchase at least one item of value;
a sequential ordering system storing an ordinal sequence of numbers for each item of value, with predetermined members of said sequence having a special price associated with said member, said unit also storing a current count location within said ordinal sequence;
a price determination unit for determining the price of the item of value, the price being assigned in accordance with the current count location within the ordinal sequence; and
a payment processing unit for processing said preauthorised purchase in accordance with the price determined by said sequential ordering system.

32. A system as claimed in claim 31 wherein said special members are determined with fixed periodicity within said sequence.

33. A system as claimed in claim 31 wherein said system is operated at a point of sale within a store environment.

34. A system as claimed in claim 31 wherein the special members are positioned randomly or pseudo randomly in accordance with a known probability distribution.

35. A system as claimed in claim 31 wherein the special members are assigned a range of prices.

36. A system as claimed in claim 31 wherein the level of precommitment is a portion of the final price.

37. A buying incentive system for providing purchases of items of value, the system including:
an interrogation device for customers to interrogate the incentive system to determine possible items of value for purchasing;
a notification device for notifying customers of the option of buying at least one item in a series of said items of value, with predetermined special members of said series being able to be purchased at a special price;
a payment processing unit for processing precommitment purchase requests from customers for items of value;
a payment adjustment unit interconnected to the notification device and payment processing unit for adjusting the level of payment in accordance with whether any of the items of value for purchasing are predetermined special members of said series.

38. A system as claimed in claim 37 wherein said notification device further includes advertising to said customer the periodicity of said special members within said series.

39. A method of providing a buying incentive to a customer for the purchasing of at least one item of value, the method comprising the steps of:
(a) advertising to a customer the option of buying at least one item in a series of said items of value, with predetermined special members of said series to be sold at a special price, said special members being unknown to said customer;
(b) providing a customer with the option to precommit to buying at least one of said items of value;
(c) utilizing said series, including any predetermined special members having a special price, to determine the total cost to said customer of the purchase; and
(d) charging the customer accordingly and fulfilling the purchasing requirements of the purchase.

40. A method as claimed in claim 39 wherein said special members have a fixed periodicity within said series.

41. A method as claimed in claim 39 wherein said step (a) further includes advertising to said customer a periodicity of said special members within said series.

42. A method as claimed in claim 39 wherein said method is operated at a point of sale within a store environment.

43. A method as claimed in claim 39 wherein the special members are positioned randomly or pseudo randomly in accordance with a known probability distribution.

44. A method as claimed in claim 39 wherein the special member is assigned a range of prices.

45. A method as claimed in claim 39 wherein the level of precommitment is a portion of the final price.
